(19) United States
(12) Patent Application Publication
(10) Pub. No.: US 2008/0024684 A1
(43) Pub. Date: Jan. 31, 2008

(54) System, medium, and method measuring geometric reliability index for image compensation

(75) Inventors: Tae-suh Park, Yongin-si (KR); Yong-beom Lee, Seoul (KR); Jong-il Park, Seoul (KR); Moon-sik Jeong, Seongnam-si (KR); Han-hoon Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., Suwon-si (KR)

(21) Appl. No.: 11/882,100

(22) Filed: Jul. 30, 2007

(30) Foreign Application Priority Data
Jul. 31, 2006 (KR) 10-2006-0072322

(51) Int. Cl. H04N 3/22

(52) U.S. Cl. 348/745; 348/E03.04

(57) ABSTRACT

A system, medium, and method measuring a geometric reliability index, e.g., in image compensation, and more particularly, a system, medium, and method measuring a geometric reliability index in image compensation that can measure a geometric model of a projection surface onto which an image is projected. The system include a pattern generating unit generating first and second patterns, each having a plurality of pattern points for image compensation and the pattern points of the first pattern being different from the pattern points of the second pattern, a pattern transmitting unit transmitting the generated first and second patterns to an image projecting system, a pattern acquiring unit acquiring the first and second patterns projected onto a projection surface by the image projecting system, and a reliability index measuring unit measuring a geometric reliability index of the projection surface on the basis of a variation in position between the corresponding pattern points of the acquired first and second patterns.

### CROSS-REFERENCE TO RELATED APPLICATIONS

This application claims priority from Korean Patent Application No. 10-2006-0072322 filed on Jul. 31, 2006 in the Korean Intellectual Property Office, the disclosure of which is incorporated herein by reference in its entirety.

### BACKGROUND

1. Field

One or more embodiments of the present invention relate to a system, medium, and method measuring a geometric reliability index, e.g., in image compensation, and more particularly, to a system, medium, and method of generating a non-distorted image on an geometrically distorted surface by estimating an geometric model of the distorted surface and projecting an image whose original image has been compensated onto the distorted surface.

2. Description of the Related Art

Generally, in order to compensate an image projected onto a projection surface, e.g., by way of a projector, the projected image is captured by a camera, and the captured image is compared with the intended projected image.

In this case, when the image is compensated by comparing the captured image with the intended projected image, accurate estimation of the geometric model of the projection surface may fail for multiple reasons, such as due to measurement errors of the camera, partial protrusions from the projection surface, limitations of utilized algorithms, etc. When an accurate estimation of a geometric model of the projection surface fails, a further compensation result of the image may have increased distortion, i.e., if the geometric model of the projection surface is incorrect any resulting compensation of the image projected onto the projection surface may result in distorted compensated images being ultimately shown on the projection surface.

Therefore, before projecting the compensated image onto the projection surface, conventionally a pattern image is first projected, and the projected image captured. Then, a geometric reliability index of the projection surface is measured, and subsequently it is determined whether to perform image compensation. When the geometric reliability index is less than a reference value, when such image compensation is performed, observable image distortion increases. For this reason, in that case, image compensation is not performed.

An example of such image compensation is discussed in US Patent Publication No. 2004-257540, where geometric distortion generated when an image is projected onto an arbitrary surface, not a pure white surface, is compensated for by estimating the geometric model of the corresponding surface, obtaining a reversed function thereof, and applying the reversed function to an original image projected to the surface.

FIG. 1 illustrates such a image pattern that can be projected onto the projection surface.

As shown in FIG. 1, the pattern image 10 includes a plurality of regular pattern points 11 that are spaced at predetermined intervals.

Therefore, when this image compensation is performed, the pattern image 10 is projected onto a projection surface and the projected image is captured, e.g., by a camera. Then, the geometric model of the projection surface may be estimated by comparing the image, as originally projected, with the captured image and image compensation may be performed based on the geometric model estimated result.

However, here, since the regular pattern points 11 are spaced at predetermined intervals, when a portion of the projection surface positioned between two pattern points protrudes or includes a glossy sticker having high reflectance at a position corresponding to the pattern point, the accurate geometric estimation of the projection surface fails. As a result, observable image distortion increases due to the incorrect image compensation, and thus the observing user is inconvenienced by the incorrect compensated image, when compared with the same image before the compensation.

Thus, US Patent Publication No. 2004-257540 discusses using a projector for an arbitrary surface that projects a compensated image of a target image by mapping the target image to an image acquired through the projection of the target image and capturing the projected image. However, since this process does not take into consideration all exceptional variables, such as partial protrusions, the geometric estimation of a screen may be incomplete or inaccurate. Further, when compensation is performed on the basis of the incomplete or incorrect geometric estimation, observable image distortion may increase after the attempted compensation.

### SUMMARY

One or more embodiments of the present invention provide a system, medium, and method measuring a geometric reliability index in image compensation that can determine whether to perform image compensation on the basis of a reliability index of a geometric model measured by projecting a plurality of patterns, each having a plurality of pattern points and the pattern points of each pattern being different from the pattern points of other patterns, and comparing geometric models estimated on the basis of the results obtained by capturing the projected patterns with each other.

Additional aspects and/or advantages of the invention will be set forth in part in the description which follows and, in part, will be apparent from the description, or may be learned by practice of the invention.

To achieve the above and/or other aspects and advantages, embodiments of the present invention include a system measuring a geometric reliability index for image compensation, the system including a pattern acquiring unit to acquire captured first and second patterns as projected onto a projection surface, and a reliability index measuring unit to measure a geometric reliability index of the projection surface based on a comparison of respective pattern points of the captured first and second patterns and corresponding respective pattern points of corresponding stored first and second patterns.

To achieve the above and/or other aspects and advantages, embodiments of the present invention include a method of measuring a geometric reliability index for image compensation, the method including acquiring captured first and second patterns as projected onto a projection surface, and measuring a geometric reliability index of the projection surface based on a comparison of respective pattern points of the captured first and second patterns and corresponding respective pattern points of corresponding stored first and second patterns.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional pattern image used for geometric estimation of a projection surface;

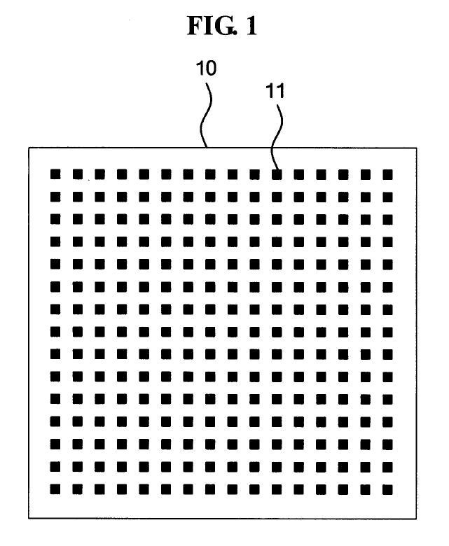

FIG. 2 illustrates an image compensating system, according to an embodiment of the invention;

FIG. 3 illustrates a reliability index measuring system, according to an embodiment of the invention;

FIG. 4 illustrates first and second patterns, according to an embodiment of the present invention;

FIG. 5 illustrates patterns obtained by projecting first and second patterns, such as those shown in FIG. 4, and capturing the projected first and second patterns;

FIG. 6 illustrates first and second patterns, according to an embodiment of the invention;

FIG. 7 illustrates a method of measuring a geometric reliability index, according to an embodiment of the invention;

FIG. 8 illustrates an image before compensation, according to an embodiment of the invention;

FIGS. 9A and 9B illustrate the case where a white edge is generated as an image compensation result when a geometric reliability index is low; and

FIGS. 10A and 10B illustrate the case where image distortion is generated as an image compensation result when a geometric reliability index is low.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

Thus, advantages and features of one or more embodiments of the present invention may be understood more readily by reference to the following detailed description of embodiments and the accompanying drawings. Embodiments of the present invention may, however, be embodied in many different forms and should not be construed as being limited to the embodiments set forth herein. Rather, embodiment descriptions are provided herein so that this disclosure will be thorough and complete and will fully convey concepts of the invention to those skilled in the art.

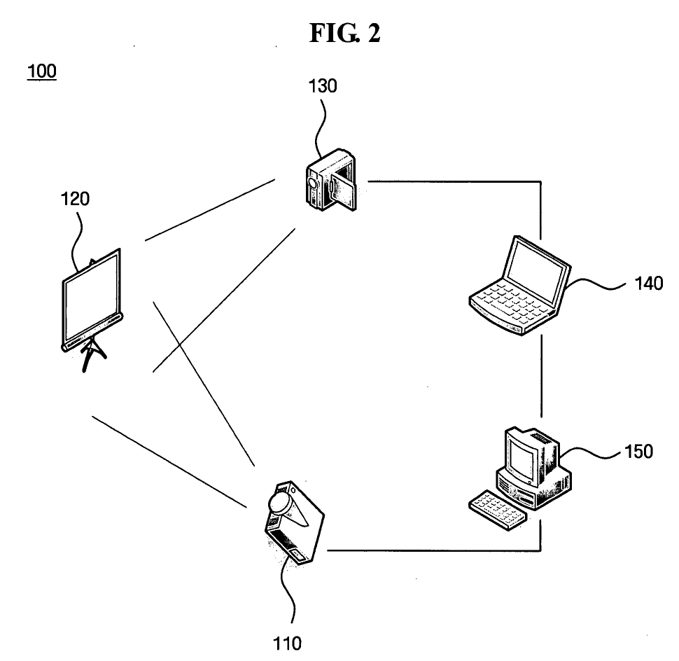

FIG. 2 illustrates an image compensating system, according to an embodiment of the invention.

As shown in FIG. 2, an image compensating system 100 may include an image projecting apparatus 110 to project an image onto a screen 120, an image capturing system 130 for capturing the projected image, an image compensating system 140 to perform image compensation by comparing the original image with the projected image, and a reliability index measuring system 150 that can measure a geometric reliability index of the screen 120.

In one embodiment, the image projecting system 110 may be a projector, such as an LCD (Liquid Crystal Display) projector, a DLP (Digital Lighting Processing) projector, or a CRT (Cathodes Ray Tube) projector, which projects an image onto a projection surface, such as the screen 120, noting that alternatives are equally available. In addition, embodiments of the present invention are explained below with reference to the case where the image projecting system 110 projects an image onto the screen 120. However, such a discussion is just an illustrative example, and embodiments of the present invention are not limited thereto. As just one example, such an image projecting system 110 may project an image onto a projection surface, such as a wall surface, onto which an image can be projected, other than the screen 120.

The image capturing system 130 may capture the image projected onto the screen 120, and may be a camera or the like. The captured image may then be forwarded to the image compensating system 140.

The image compensating system 140 may compare the image as projected, e.g., by the image projecting system 110, with the captured image and compensate the image to be projected by controlling the image projecting system 110 based on the comparison result, for example.

When the image compensating system 140 performs image compensation, for example, the reliability index measuring system 150 may detect the case where distorted image compensation would result from a geometric model estimating result that is distorted due to background noise, unevenness of the screen 120, or a glossy sticker on the screen 120, for example, and instruct the image compensating system 140 to not perform the image compensation to avoid an increase in image distortion and a user's inconvenience through projection of the incorrectly compensated image. Here, in this case, a user may also be informed that the screen is not appropriate for image projection.

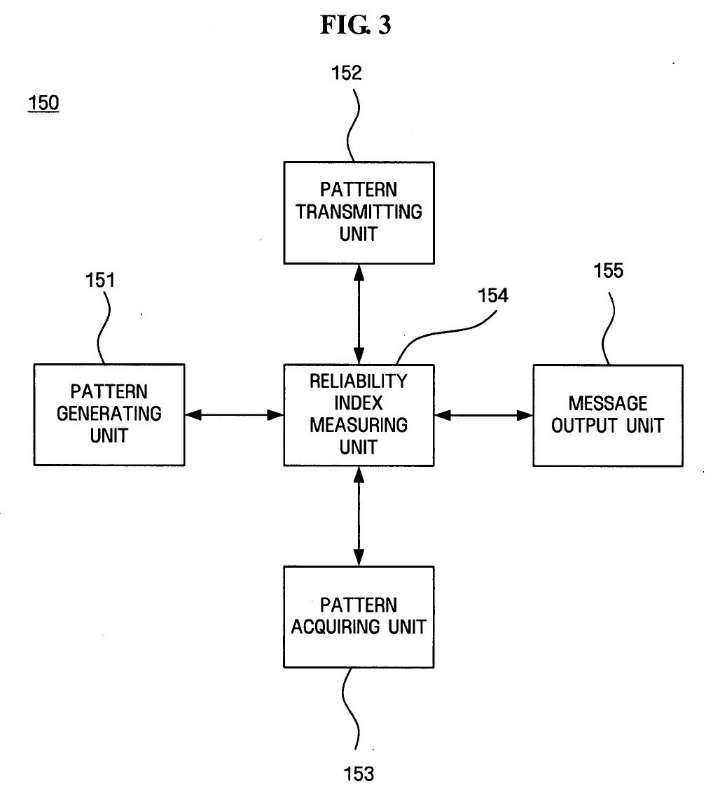

FIG. 3 illustrates a reliability index measuring system, according to an embodiment of the invention.

As shown in FIG. 3, a reliability index measuring system, such as the reliability index measuring system 150 of FIG. 2, according to the embodiment of the invention, may include a pattern generating unit 151 to generate first and second patterns having at least some different pattern points, a pattern transmitting unit 152 that can forward the generated first and second patterns to the image projecting system 120 to be projected onto the screen 120, a pattern acquiring unit 153 that may capture the first and second patterns projected by the image projecting system 110, a reliability index measuring unit 154 that may determine the geometric reliability index of the screen based on a variation in position of a geometric model estimated according to the pattern points of the captured first and second patterns, and a message output unit 155 that may output a message, e.g., when the determined geometric reliability index fails or indicates that a derivable geometric model of the screen surface would result in a distorted compensated image.

The pattern generating unit 151 may generate the first and second patterns, e.g., on the condition that at least a plurality of pattern points included in the first pattern and the second pattern do not overlap one another, and the positions of the pattern points included in the second pattern can be assigned based on the pattern points included in the first pattern, for example.

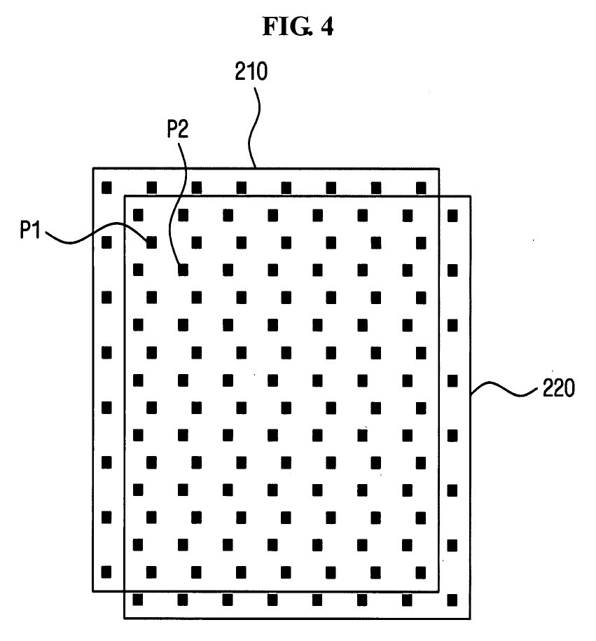

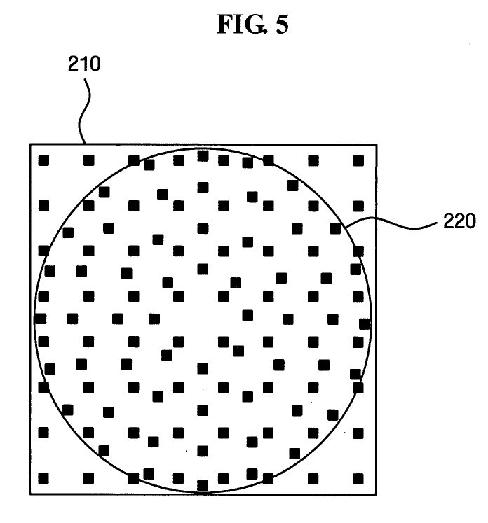

As illustrated in FIG. 4, the pattern generating unit 151 may generate a first pattern 210 and a second pattern 220, each having a plurality of pattern points. In an embodiment, the generated first and second patterns 210 and 220 may have the same shapes in a plurality of pattern points and/or may have different shapes in a plurality of pattern points, with at least a plurality of the pattern points of the first pattern 210 not overlapping the pattern points of the second pattern 220. For example, the pattern generating unit 151 may generate the first pattern 210 to have a plurality of pattern points arranged in a regular lattice shape and a second pattern 220 to have a plurality of pattern points arranged circularly, as shown in FIG. 5. Hereinafter, for simplicity of explanation, a geometric model according to the first and second patterns generated by such a pattern generating unit 151, e.g., before projection, and potentially then stored in a memory, will be referred to as a first geometric model.

The above-mentioned shapes of the plurality of pattern points included in the first and second patterns 210 and 220, e.g., as shown in FIGS. 4 and 5, are just illustrative examples, with embodiments of the invention not being limited thereto. For example, the shape of the plurality of pattern points may be changed according to the screen 120, the environment, and the like. In addition, as another example, when the screen 120 is a wall surface covered with a vertically striped wallpaper, it may be possible to use, as the first pattern, a pattern having vertical edges sensitive to a variation in a horizontal direction and to use, as the second pattern, another pattern having oblique diagonal edges insensitive to the variation in the horizontal direction. Here, again, it is noted that alternative embodiments are equally available.

The pattern acquiring unit 153 may acquire the captured first and second patterns, e.g., as captured by the image capturing system 130 of FIG. 2. Hereinafter, in this embodiment, a geometric model according to such acquired captured first and second patterns, as projected, will be referred to as a second geometric model.

The reliability index measuring unit 154 may judge the geometric reliability index of an estimated model of the screen 120, for example, by comparing the relative positions between the pattern points of the first pattern and the pattern points of the second pattern. Specifically, an area under the influence of various factors, such as partial protrusion, illumination, dark spot, twinkling glossy sticker, or the like, which may cause an error in the geometric estimation, can be limited and the level of the influence thereof varies according to the position. For this reason, the possibility can be lessened that the same factor causing an error in the geometric estimation has the same level of influence on the two pattern points positioned at different positions. Accordingly, when the difference among geometric models, e.g., independently estimated by a plurality of different reference patterns, is small, minimizing the influence of factors causing errors on the geometric estimation for a corresponding compensation system, it may be assumed that a geometric model result is reliable.

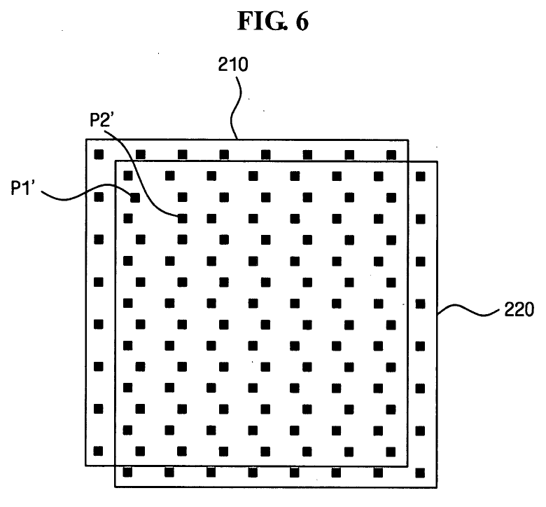

More specifically, in an embodiment, the reliability index measuring unit 154 may obtain a first geometric model according to first pattern points P1 of the first pattern 210 and second pattern points P2 of the second pattern 220 to be projected on a screen, such as patterns 210 and 220 shown in FIG. 4, and a second geometric model according to captured first pattern points P1′ and second pattern points P2′ of the first and second pattern 210 and 220, such as shown in FIG. 6, e.g., as captured by the image capturing system 130. Then, in one embodiment, the reliability index measuring unit 154 may compare coordinates of the first and second pattern points P1 and P2 of the first geometric model with the coordinates of the first and second pattern points P1′ and P2′ of the second geometric model corresponding to the first and second pattern points P1 and P2. If the difference therebetween is less than a reference value, the reliability index measuring unit 154 may judge that the geometric reliability index is high, i.e., that the geometric reliability has passed or not failed. If the difference is greater or meets a reference value, the reliability index measuring unit 154 may judge that the geometric reliability index is low, i.e., that the geometric reliability has failed. Such a mutual verification through a comparison between the first and second geometric models may also be performed by obtaining vectors connecting two arbitrary pattern points of the first and second patterns 210 and 220 and comparing a change between the corresponding vectors in the first and second geometric models, rather than the point-to-point comparison, noting that alternative embodiments are equally available.

As an example, if the judged geometric reliability index is high or passes, the reliability index measuring unit 154 may instruct the image compensating system 140 to perform the image compensation. If the judged geometric reliability index is low or fails, the reliability index measuring unit 154 may instruct the image compensating system 140 to not to perform the image compensation. Accordingly, it is possible to avoid performing compensation that may distort the projected image. Here, the reliability index is meant to demonstrate an index of potential reliability of a potentially projected compensated image, i.e., that the geometric model of the screen appears sufficiently correct that if compensation were to be performed the resultant compensated image would be projected as desired. If the reliability index is high or passes, then compensation may be performed, and if the reliability index is low or fails, then compensation may be avoided.

Above, such an embodiment where the reliability index measuring unit 154 determines the geometric reliability index based on the vector difference or distance difference has only been described as an example, and embodiments of the present invention are not limited thereto. Further, it should be apparent that it is possible to judge the geometric reliability index using various methods capable of judging a variation in position at least between pattern points of first and second patterns in first and second geometric models.

As noted, in an embodiment, when the geometric reliability index, e.g., measured by the reliability index measuring unit 154, has failed, the message output unit 155 may output a message informing the user that the image compensation is not performed or a message informing the user that, since the screen 120 onto which an image is projected is inappropriate to perform image compensation, the image should be projected onto another screen. In such a case, the user can easily check whether the image projected onto the screen 120 is not successfully compensated or whether another screen should be used instead of the screen 120, and can rapidly cope with the situation.

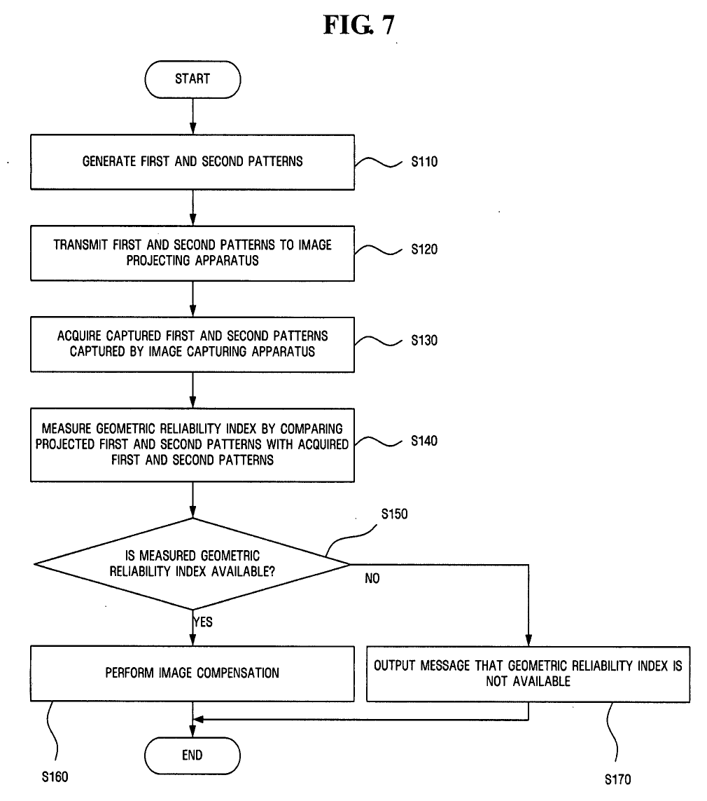

FIG. 7 illustrates a method of measuring a geometric reliability index, e.g., in image compensation, according to an embodiment of the present invention.

As shown in FIG. 7, a first pattern and a second pattern, each having a plurality of differing pattern points, may be generated, e.g., by the pattern generating unit 151, in operation S110. The first and second patterns may be generated such that the plurality of pattern points of the first pattern do not overlap the plurality of pattern points of the second pattern, for example. In one embodiment, the case where the pattern generating unit 151 generates the first and second pattern, e.g., to be projected on a screen, has been described only as an example, and alternate embodiments are equally available. In an embodiment, the pattern generating unit 151 may generate the plurality of patterns such that pattern points of each pattern do not overlap.

The first and second patterns, e.g., generated by the pattern generating unit 151, may be forwarded for projection, e.g., by the pattern transmitting unit 152 to the image projecting system 110, in operation S120. Then, the first and second patterns may be projected onto the screen 120, e.g., by the image projecting apparatus 110.

When the projected first and second patterns are captured, e.g., by the image capturing system 130, the captured first and second patterns may then be acquired from the system capturing the patterns for comparison, e.g., by the pattern acquiring unit 153, in operation S130.

The geometric reliability index of an estimated screen model may be judged, e.g., by the reliability index measuring unit 154, by comparing positions between corresponding pattern points of first and second geometric models, in operation S140. In an embodiment, the corresponding pattern points among the first and second patterns can be understood as the pattern points of the first pattern and the pattern point of the second pattern obtained when the pattern points go through a predetermined computing process. For example, when the pattern points of each of the first and second pattern are arranged in a regular lattice shape, a predetermined pattern point of the second pattern corresponding to a predetermined pattern point of the first pattern may be spaced from the predetermined pattern point of the first pattern by a predetermined distance in X and Y directions. Such a computing process may be variously modified according to the arrangement shape of the pattern points of each of the first and second patterns, and alternate comparisons can be performed.

When the geometric reliability index, e.g., measured by the reliability index measuring unit 154, passes or “is available”, in operation S150, that is, when a compensation process, e.g., by the image compensating system 140, can be used to improve an image, such an image compensating system 140 may perform the image compensation, in operation S160.

When the geometric reliability index, e.g., measured by the reliability index measuring unit 154, fails or “is not available”, that is, when a compensation process would raise image degradation and increase the inconvenience of the user, a message may be output indicating that the image compensation has stopped or that the screen 120 is inappropriate to perform the image compensation, in operation S170.

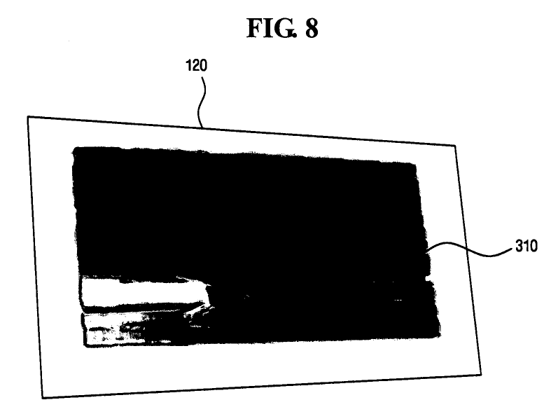

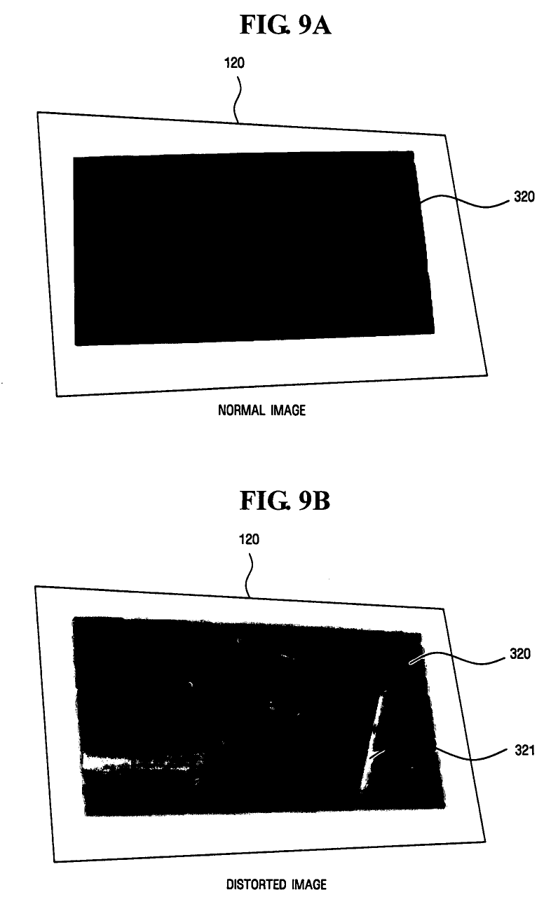

FIG. 8 illustrates an image 310 for which an image compensation has not yet been performed, as projected to the screen 120 When image compensation is performed in a state where the geometric reliability index is low the projected compensated image 320 includes a white edge 321, as shown in FIG. 9B, compared with a normal compensated image 320 shown in FIG. 9A. Thus, according to one or more embodiments of the present invention, in a system, medium, and method measuring a geometric reliability index in image compensation, it is possible to prevent such a white edge form being generated by preventing the projecting of a compensated image that is based on an incorrect geometric model of the screen.

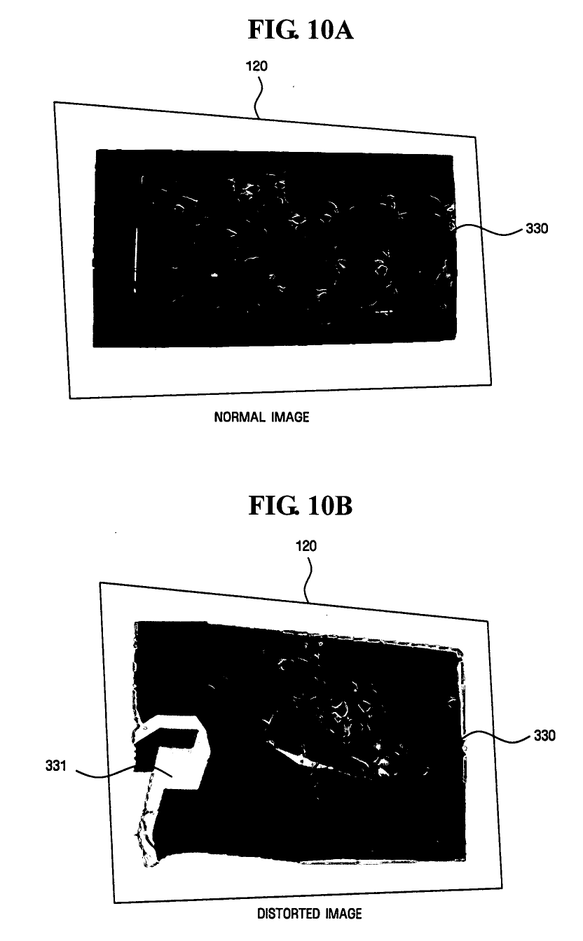

In addition, as shows in FIGS. 10A and 10B, it is possible to prevent the performance of an image compensation process on the normal image 330 shown in FIG. 10A when the geometric reliability index would fail, such that the projection of the observable distortion of a corresponding compensated image 330 with the white edge 331 shown in FIG. 10B can be avoided.

Embodiments of the present invention may have been described above with reference to block diagrams or flowchart illustrations of a system and/or method measuring a geometric reliability in image compensation. It will be understood that each block of the flowchart illustrations, and combinations of blocks in the flowchart illustrations can be implemented by computer program code or instructions. Such codes or instructions can be provided to a processor of a general purpose computer, special purpose computer, or other programmable data processing system to produce a machine, such that the instructions, which execute via the processor of the computer or other programmable data processing system, create mechanisms for implementing the operations specified in the flowchart block or blocks. These codes or instructions may also be stored in a computer usable or computer-readable memory that can direct a computer or other programmable data processing system to operate in a particular manner, such that the instructions stored in the computer usable or computer-readable memory produce an article of manufacture including instruction mechanisms that implement the operation specified in the flowchart block or blocks. The code or instructions may also be loaded onto a computer or other programmable data processing system to cause a series of operational processes to be performed on the computer or other programmable system to produce a computer implemented process such that the instructions that execute on the computer or other programmable system provide a way for implementing the operations specified in the flowchart block or blocks.

In addition, each block of the block diagrams may represent a module, segment, or portion of code, which includes one or more executable instructions for implementing the specified logical operation(s). It should also be noted that in some alternative implementations, the operations noted in the blocks may occur out of order. For example, two blocks shown in succession may in fact be executed substantially concurrently or the blocks may sometimes be executed in reverse order depending upon the operations involved.

Further, in this regard, the term “unit,” as used herein, may mean, but is not limited to, a software or hardware component, such as a Field Programmable Gate Array (FPGA) or an Application Specific Integrated Circuit (ASIC), which performs certain tasks. A unit may advantageously be configured to reside on the addressable storage medium and configured to be executed on one or more processors. Accordingly, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operation provided for in the components and units may be combined into fewer components and units or further separated into additional components and units.

With this in mind, and in addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to a system, medium, and method, according to an embodiment of the present invention, measuring a geometric reliability index, e.g., in image compensation, the geometric reliability index of the projection surface onto which an image is projected may be measured using the first and second patterns different from each other and image compensation may be performed only in the case where compensation quality can be ensured. Therefore, in such an embodiment, it is possible to prevent image degradation due to an erroneous estimation. As a result, it is possible to improve sensory quality of an image compensating system.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system measuring a geometric reliability index for image compensation, the system comprising:
a pattern acquiring unit to acquire captured first and second patterns as projected onto a projection surface; and
a reliability index measuring unit to measure a geometric reliability index of the projection surface based on a comparison of respective pattern points of the captured first and second patterns and corresponding respective pattern points of corresponding stored first and second patterns.

2. The system of claim 1, further comprising a pattern generating unit to generate the stored first and second patterns for projection onto the projection surface, each pattern having a plurality of differently positioned pattern points available for image compensation.

3. The system of claim 1, further comprising a pattern transmitting unit to transmit the generated first and second patterns to an image projecting system for projecting an image on the projection surface.

4. The system of claim 3, further comprising the image projecting system.

5. The system of claim 1, further comprising an image capturing system to capture the projected first and second patterns.

6. The system of claim 1, wherein:
pattern points of the stored first pattern do not overlap pattern points of the stored second pattern; and
positions of the pattern points of the stored second pattern are assigned based on positions of the pattern points of the stored first pattern for generation of a geometric model of the projection surface.

7. The system of claim 1, wherein the reliability index measuring unit measures the geometric reliability index based upon a comparison of a first geometric model, derived from the captured first pattern and the stored first pattern, and a second geometric model, derived from the captured second pattern and the stored second pattern.

8. The system of claim 1, wherein the reliability index measuring unit determines a vector difference between a first vector of a pattern point of the stored first pattern a pattern point of the stored second pattern and a second vector of a pattern point of the captured first pattern and a pattern point of the captured second pattern, and judges whether the measured geometric reliability index fails by comparing the determined vector difference with a reference value.

9. The system of claim 1, wherein the reliability index measuring unit determines a distance difference between distances of corresponding pattern points of the captured first pattern and the stored first pattern and distances of corresponding pattern points of the captured second pattern and the stored second pattern, and judges whether the measured geometric reliability index has failed by comparing the determined distance difference with a reference value.

10. The system of claim 1, wherein the reliability index measuring unit determines a distance difference between distances of corresponding pattern points of the stored first pattern and the stored second pattern and distances of corresponding pattern points of the captured first pattern and the captured second pattern, and judges whether the measured geometric reliability index has failed by comparing the determined distance difference with a reference value.

11. The system of claim 1, wherein the reliability index measuring unit judges that the geometric reliability index of the projection surface has not failed when a variation in position between respective pattern points of the stored first or second pattern and the captured first or second pattern does not meet a reference value, and judges that the geometric reliability index of the projection surface has failed when the variation in position meets the reference value.

12. The system of claim 11, wherein, when the measured geometric reliability index does not fail, the reliability index measuring unit controls an image compensating system to perform the image compensation.

13. The system of claim 11, further comprising a message output unit to output a message according to a judgment result of the geometric reliability index measuring unit.

14. The system of claim 13, wherein, when the geometric reliability index fails, the message output unit outputs at least one of a message indicating that the image compensation has stopped and a message that the projection surface is inappropriate.

15. The system of claim 1, further comprising an image compensating system to perform image compensation.

16. A method of measuring a geometric reliability index for image compensation, the method comprising:
acquiring captured first and second patterns as projected onto a projection surface; and
measuring a geometric reliability index of the projection surface based on a comparison of respective pattern points of the captured first and second patterns and corresponding respective pattern points of corresponding stored first and second patterns.

17. The method of claim 16, further comprising generating the stored first and second patterns for projection onto the projection surface, each pattern having a plurality of differently positioned pattern points available for image compensation.

18. The method of claim 16, further comprising projecting the stored first and second patterns on the projection surface through an image projecting system for projecting an image on the projection surface.

19. The method of claim 16, further comprising capturing the stored first and second patterns, as the captured first and second patterns, as projected on the projection surface.

20. The method of claim 16, wherein:
pattern points of the stored first pattern do not overlap pattern points of the stored second pattern; and
positions of the pattern points of the stored second pattern are assigned based on positions of the pattern points of the stored first pattern for generation of a geometric model of the projection surface.

21. The method of claim 16, wherein the measuring of the geometric reliability index comprises measuring the geometric reliability index based upon a comparison of a first geometric model, derived from the captured first pattern and the stored first pattern, and a second geometric model, derived from the captured second pattern and the stored second pattern.

22. The method of claim 16, wherein the measuring of the geometric reliability index comprises determining a vector difference between a first vector of a pattern point of the stored first pattern a pattern point of the stored second pattern and a second vector of a pattern point of the captured first pattern and a pattern point of the captured second pattern, and judging whether the measured geometric reliability index fails by comparing the determined vector difference with a reference value.

23. The method of claim 16, wherein the measuring of the geometric reliability index comprises determining a distance difference between distances of corresponding pattern points of the captured first pattern and the stored first pattern and distances of corresponding pattern points of the captured second pattern and the stored second pattern, and judging whether the measured geometric reliability index has failed by comparing the determined distance difference with a reference value.

24. The method of claim 16, the measuring of the geometric reliability index comprises determining a distance difference between distances of corresponding pattern points of the stored first pattern and the stored second pattern and distances of corresponding pattern points of the captured first pattern and the captured second pattern, and judging whether the measured geometric reliability index has failed by comparing the determined distance difference with a reference value.

25. The method of claim 16, wherein the measuring of the geometric reliability index comprises judging that the geometric reliability index of the projection surface has not failed when a variation in position between respective pattern points of the stored first or second pattern and the captured first or second pattern does not meet a reference value, and judging that the geometric reliability index of the projection surface has failed when the variation in position meets the reference value.

26. The method of claim 16, wherein the measuring of the geometric reliability index comprises controlling a compensating of an image when the measured geometric reliability index does not fail.

27. The method of claim 16, further comprising outputting a message based on a result of the measuring of the geometric reliability index.

28. The method of claim 27, wherein the outputting of the message comprises outputting at least one of a message indicating that the image compensation has stopped and a message that the projection surface is inappropriate, when the geometric reliability index fails.

29. At least one medium comprising computer readable code to control at least one processing element to implement the method of claim 16.
